(19) United States
(12) Patent Application Publication
(10) Pub. No.: US 2015/0144541 A1
(43) Pub. Date: May 28, 2015

(54) WATER FILTER SAND LEVEL SENSOR

(71) Applicant: Deere & Company, Moline, IL (US)

(72) Inventors: KARTHIKEYAN BALASUBRAMANIAN, MADURAI (IN); KUMAR B. NAVEEN, DODDABALLAPUR TALLUK BANGALORE (IN); BHANU KIRAN PALLA, HYDERABAD (IN); SWARNMANI SINGH, PUNE (IN)

(73) Assignee: Deere & Company, Moline, IL (US)

(21) Appl. No.: 14/091,655

(22) Filed: Nov. 27, 2013

(51) Int. Cl. B01D 24/48

(52) U.S. Cl. CPC B01D 24/4869
USPC 210/86

(57) ABSTRACT

A water filter sand level sensor is positioned inside a water filter and detects if a sand level in the water filter is above or below a critical level. The sand level sensor is connected to an indicator outside the water filter that provides a visual or audible signal regarding the sand level in the water filter. The sand level sensor may be a light dependent resistor detecting light from a light emitting diode and having a resistance that decreases with increasing incident light intensity. The sand level sensor also may be an ultrasonic transducer transmitting ultrasonic energy bursts vertically down through the water filter to the sand level and determining a time difference between a transmitted and a reflected signal.

### FIELD OF THE INVENTION

This invention relates to for water filters used in drip irrigation systems.

### BACKGROUND OF THE INVENTION

Water filters are commonly used in drip irrigation systems to filter water from wells, tanks, open reservoirs, recycled water, canals, rivers and lakes that may have suspended impurities such as silt, algae, and other organic particles. These water filters predominantly use sand as the medium to filter out these impurities. As water passes through the sand, the suspended impurities are retained above the sand in the filter unit, so that the water percolates through the sand as filtered water free from the impurities. This filtering process is essential to prevent clogging of drip pipes or conduits for drip irrigation systems.

The sand retains the impurities on top of the bed in the water filter, but it eventually may start clogging and thereby reduce the flow of water through the sand. This may be detected by measuring the water pressure differential between the inlet and outlet of the water filter. Once the pressure differential increases beyond a threshold, maintenance on the filter may be needed. The maintenance may include back-flushing the filter to remove the impurities settled on top of the sand bed. During back-flushing, the direction of water flow through the filter is reversed so that the water passes from the bottom of the sand bed and percolates in the upward direction to suspend the impurities settled on top of the bed. The suspended impurities then may be flushed out of the filter through the top inlet manifold of the filter, hence removing the impurities out of the filter.

However, during back flushing some of the sand in the filter may also get suspended and flushed out of the filter. The sand level may decrease below the level that is required for effective filtering operation. Without adequate sand, the filter may not effectively remove impurities which may block irrigation pipes.

In the past, the lid or cover of a water filter must be opened to check the sand level on a daily basis. This may be difficult due to high water pressure during operation, which also may persist during a non-operational state. The remaining water in the tank may need to be drained to release the pressure within the tank. Additionally, repeated opening of the tank may lead to damage to a seal between the tank and lid or cover. A water filter sand level sensor is needed to check the sand level without opening the filter. A water filter sand level sensor is needed that will notify the operator before the sand level becomes too low to effectively filter out impurities.

### SUMMARY OF THE INVENTION

A water filter sand level sensor is positioned inside a water filter and detects if a sand level in the water filter is above or below a critical level. The sand level sensor is connected to an indicator light or warning alarm outside the water filter that provides a visual or audible signal regarding the sand level in the water filter. The sand level sensor may be a light dependent resistor detecting light from a light emitting diode and having a resistance that decreases with increasing incident light intensity. The sand level sensor also may be an ultrasonic transducer transmitting ultrasonic energy bursts vertically down through the water filter to the sand level and determining a time difference between a transmitted and a reflected signal.

The water filter sand level sensor does not require opening the water filter to check the sand level. The water filter sand level sensor will notify the operator before the sand level becomes too low to effectively filter out impurities.

### BRIEF DESCRIPTION OF THE DRAWINGS

FIG. 1 is a side view of a water filter with a sand level sensor above the critical level according to a first embodiment of the invention.

FIG. 2 is a side view of a water filter with a sand level sensor below the critical level according to a first embodiment of the invention.

FIG. 3 is a perspective view of a water filter with a sand level sensor above the critical level according to a second embodiment of the invention.

FIG. 4 is a circuit diagram of a water filter sand level sensor below the critical level according to a second embodiment of the invention.

### DESCRIPTION OF THE PREFERRED EMBODIMENT

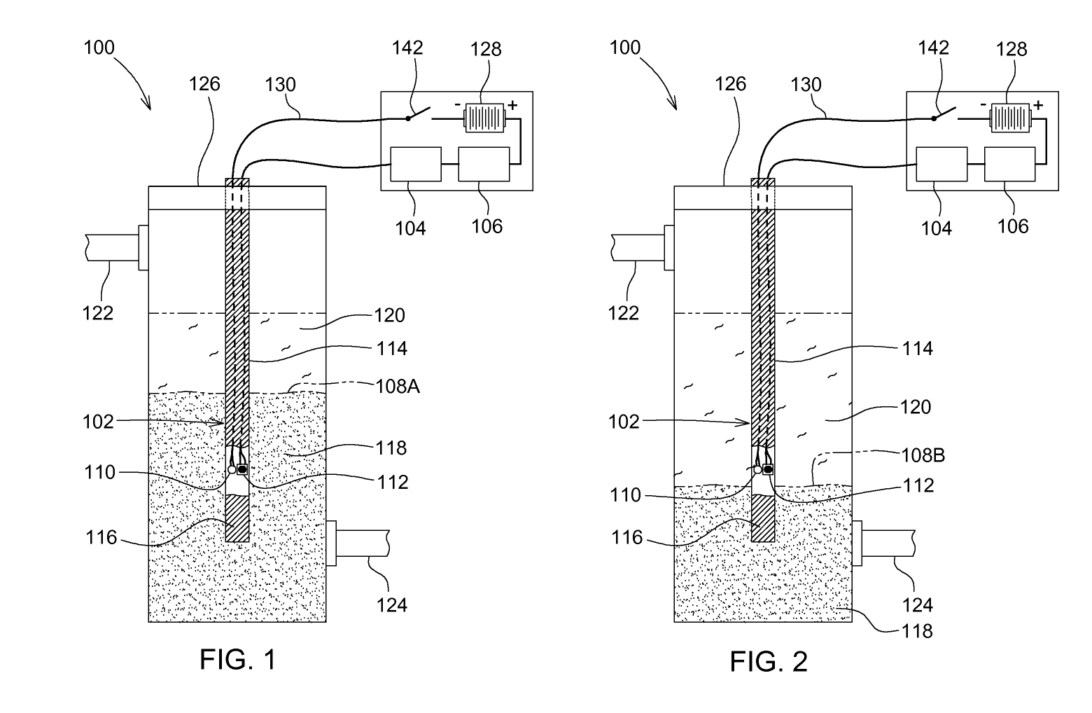

FIGS. 1-2 show water filter 100 provided with a first embodiment of sand level sensor 102. Sand level sensor 102 may be positioned inside the water filter and may be connected to an indicator such as a light 104 or warning alarm 106 positioned outside the water filter. For example, the sand level sensor may turn on an indicator light if the sensor detects sand or other filtering media is at or above a critical level as shown by sand level 108a in FIG. 1, and may turn off the indicator light if the sensor detects sand or other filtering media is below the critical level as shown by sand level 108b in FIG. 2.

In the first embodiment, sand level sensor 102 may include photoresistor or light dependent resistor (LDR) 110 and general purpose light emitting diode (LED) 112. The photoresistor or LDR may detect light from the LED, and has resistance that decreases with increasing incident light intensity. The resistance of the photoresistor or LDR may be used to turn on or off the indicator light.

In the first embodiment, both the photoresistor or LDR and the LED may be enclosed in transparent housing 114 which may be a clear glass or plastic tube or pipe. The photoresistor or LDR and LED preferably may be mounted less than about 1 mm apart from each other. The transparent housing may be vertically aligned so the photoresistor or LDR and the LED are fixed at a critical position of sand inside the water filter, and the transparent housing above and below the photoresistor or LDR and the LED may be provided with sealant 116.

FIG. 1 shows sand level 108a above the photoresistor or LDR and LED of the sand level sensor, so the photoresistor or LDR may detect a first or high level of light from the LED due to light reflections from sand particles 118. As a result, the photoresistor or LDR may have low resistance, indicating a sand level that is at or above the critical level. FIG. 2 shows sand level 108b below the photoresistor or LDR and LED of the sand level sensor, so the photoresistor or LDR may detect a lower level of light from the LED due to lower light reflections from water 120 than sand. As a result, the photoresistor or LDR may have a higher resistance, indicating a sand level that is below the critical level.

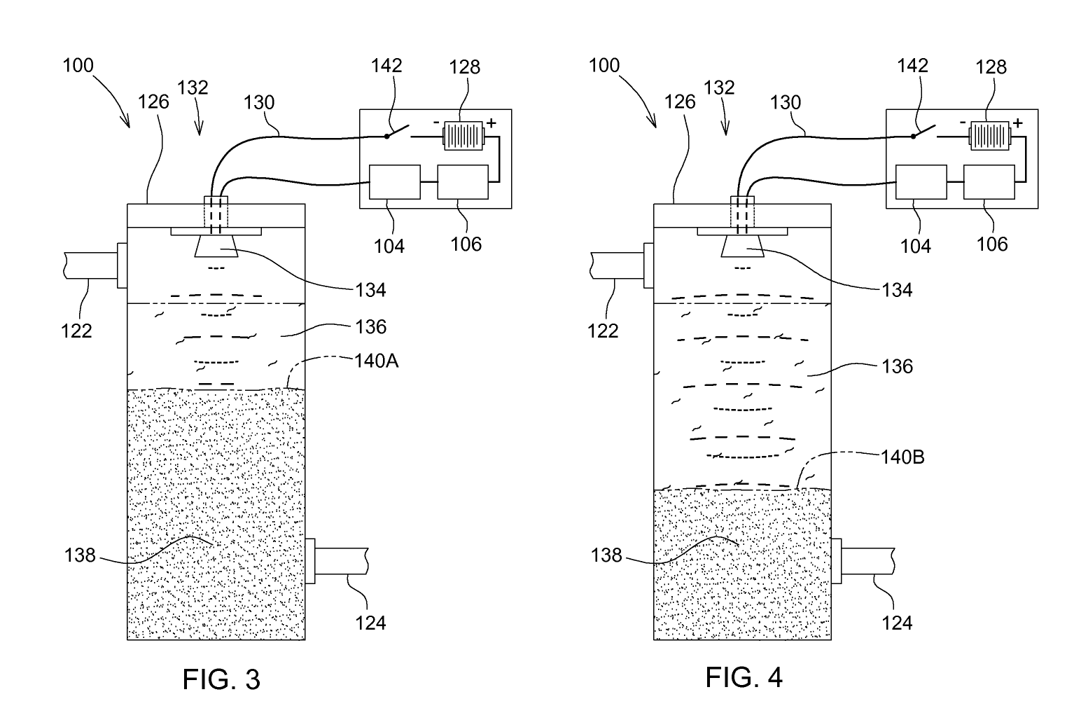

FIGS. 3-4 show water filter 100 with a second embodiment of sand level sensor 132. In the second embodiment, sand level sensor 132 may include ultrasonic transducer 134 which may transmit ultrasonic energy bursts or waves through water 136 in the water filter, and that may be reflected back by sand 138 or other filtering media. The ultrasonic transducer may be a piezoelectric device that converts electrical impulses into mechanical vibrations, and may be positioned at or near the top of the water filter. The ultrasonic transducer may transmit ultrasonic energy bursts or waves down vertically through the water and reflected waves back to the transducer. For example, a set of five pulses may be generated and transmitted at intervals of 100 ms. The time span between generation of the ultrasonic signals and the reflection may be used to compute the distance to the sand or other media. FIG. 3 shows sand level 140a above the critical level, so the time difference Δt between a transmitted and reflected signal will be less than a specified value. FIG. 4 shows sand level 140b below the critical level, so the time difference Δt between a transmitted and reflected signal will be greater than the specified value.

In the first and second embodiments, unfiltered water may enter water filter 100 through inlet pipe 122 and may exit through outlet pipe 124. The sand 118 or other filtering media may retain impurities on top of the sand bed in the filter. This may be detected by measuring the water pressure differential between the inlet and outlet. Once the pressure differential is above a threshold, the filter may be back-flushed to remove impurities settled on top of the sand bed. To back-flush, the direction of water flow may be reversed so that water enters the filter through outlet pipe 124 near the bottom of the sand bed, and suspended impurities may be flushed out through inlet 122 near the top of the filter.

In the first and second embodiments, the sand level sensor may be electrically connected to a circuit having an indicator light 104 and/or warning alarm 106 located outside the water filter. The circuit also may include electrical power source 128 outside the water filter. The electrical power source may include a plurality of cells in series, such as four 1.5V lithium iodide button cells in series. The circuit also may include actuation switch 142 outside the water filter that an operator may use to turn on and off the sand level sensor to minimize power consumption. Electrical connections from the sand level sensor may include wires 130 extending upwardly inside the transparent housing of the first embodiment and through the lid or cover 126 sealing the top of the water filter.

Having described the preferred embodiment, it will become apparent that various modifications can be made without departing from the scope of the invention as defined in the accompanying claims.

1. An apparatus comprising:
a sand level sensor positioned inside a water filter;
an indicator positioned outside the water filter and connected to the sand level sensor and providing a visual or audible signal regarding a sand level in the water filter;
the sand level sensor including a light dependent resistor and a light emitting diode enclosed in a transparent housing positioned at a critical level of sand in the water filter; the LDR detecting light from the LED and having a resistance that decreases with increasing incident light intensity; the sand level indicator turning on or off in response to the resistance of the LDR.

2. The apparatus of claim 1 further comprising an actuation switch turning on and off the sand level sensor.

3. The apparatus of claim 1 wherein the housing is a tube.

4. The apparatus of claim 1 further comprising a battery unit connected to the sand level sensor and the indicator.

5. An apparatus comprising:
a sand level sensor positioned inside a water filter;
an indicator positioned outside the water filter and connected to the sand level sensor and providing a visual or audible signal regarding a sand level in the water filter;
the sand level sensor including an ultrasonic transducer transmitting ultrasonic energy bursts vertically down through the water filter to the sand level and determining a time difference between a transmitted and a reflected signal; the indicator turning on or off in response to the time difference between the transmitted and reflected signals from the ultrasonic transducer.

6. The apparatus of claim 5 further comprising an actuation switch turning on and off the sand level sensor.

7. The apparatus of claim 5 further comprising a battery unit connected to the sand level sensor and the sand level indicator.

8. An apparatus comprising:
a sand level sensor positioned inside a water filter and detecting if a sand level in the water filter is above or below a critical level;
an indicator positioned outside the water filter and connected to the sand level sensor and providing a visual or audible signal regarding the sand level in the water filter;
an electrical power source connected to and powering the sand level sensor and the indicator; and
an actuation switch turning on and off the sand level sensor.

9. The apparatus of claim 8 wherein the sand level sensor includes a light dependent resistor and a light emitting diode enclosed in a transparent housing positioned in the water filter; the LDR detecting light from the LED and having a resistance that decreases with increasing incident light intensity.

10. The apparatus of claim 8 wherein the sand level sensor includes an ultrasonic transducer transmitting ultrasonic energy bursts vertically down through the water filter to the sand level and determining a time difference between a transmitted and a reflected signal.
